(19) United States
(12) Patent Application Publication
(10) Pub. No.: US 2016/0381541 A1
(43) Pub. Date: Dec. 29, 2016

(54) SYSTEMS AND METHODS FOR A MOBILE UAV-BASED EMERGENCY COMMUNICATION SCANNER

(71) Applicants: David Akopian, San Antonio, TX (US); Chunjiang Qian, San Antonio, TX (US); Daniel Pack, San Antonio, TX (US)

(72) Inventors: David Akopian, San Antonio, TX (US); Chunjiang Qian, San Antonio, TX (US); Daniel Pack, San Antonio, TX (US)

(21) Appl. No.: 15/194,356

(22) Filed: Jun. 27, 2016

Related U.S. Application Data
(60) Provisional application No. 62/184,745, filed on Jun. 25, 2015.

(51) Int. Cl. H04W 4/22; H04W 4/00; H04W 4/14; H04B 1/40

(52) U.S. Cl. CPC H04W 4/22; H04B 1/40; H04W 4/005; H04W 4/14; H04W 84/18

(57) ABSTRACT

Disclosed herein are systems and methods for communication scanners, which utilize mobile-based platforms to facilitate the communications. In an embodiment, the mobile UAV based emergency communication scanner is comprised of an unmanned aerial vehicle (UAV), deployed sensor resources, mapping application and a big-data center. The present invention discloses a mobile UAV system that is configured to collect sensory data from the sensor resources deployed in embodiments of phones, GPS and other activity signals. The disclosed systems and methods improve upon emergency response systems where data collection may be limited and communication channels may not be available. The system and methods may be utilized in a multitude of ways, including but not limited to search and rescue operations.

### CROSS-REFERENCE TO RELATED APPLICATIONS

This application claims the benefit under Title 35 United States Code §119(e) of U.S. Provisional Patent Application Ser. No. 62/184,745; Filed: Jun. 25, 2015, the full disclosure of which is incorporated herein by reference.

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### INCORPORATING-BY-REFERENCE OF MATERIAL SUBMITTED ON A COMPACT DISC

Not applicable

### SEQUENCE LISTING

Not applicable

### FIELD OF THE INVENTION

The present invention generally relates to systems and methods for communication scanners. More specifically, the present invention relates to systems and methods for communication scanners, which utilize mobile-based platforms to facilitate the communications.

### BACKGROUND OF THE INVENTION

Without limiting the scope of the disclosed systems and methods, the background is described in connection with a novel system and approach directed to a mobile UAV-based emergency communication scanner.

### 1. Existing Public Emergency Services

The first North American emergency call number was the 911 system deployed in Winnipeg, Manitoba, Canada in 1959. The first United States 911 emergency phone system was set up in Alabama in 1968 and it was standardized in the 1980s as the official emergency contact number across most of the North American Numbering Planning (NANP) [1]. Enhanced 9-1-1 or E911 service is a North American telecommunications based system that automatically associates a physical address with the calling party's telephone number [2], and routes the call to the most appropriate Public Safety Answering Point (PSAP) [3] for that address. The caller's address and information is displayed to the PSAP call taker immediately upon call arrival. This provides emergency responders with the location of the emergency without the person calling for help and having to provide the location information. E911 is currently deployed in most metropolitan areas in the United States of America.

The telephone number 3-1-1 is a special non-emergency N-1-1 number [1] in many communities in the United States that provides quick, easy-to-remember access to non-emergency municipal services or a Citizen Service Center. Overall there are 8 such N-1-1 numbers as defined within NANP that are functional in different parts of the country, in place to improve public safety using the existing telecommunication infrastructure.

Federal Emergency Management Agency (FEMA) is created to prepare for, prevent, respond to and recover from disasters with a vision of “A Nation Prepared”. Different from the E911 mission, FEMA is more focused on institutional preparedness and coordination of government and related rescue activities [4].

### 2. Commercial Safety Services

Rave Wireless [5]. Rave Wireless is a developer and provider of safety applications for mobile phone users targeting personal security, mass emergency notification through text messaging and campus security. Some of their commercial products are the following. Rave Alert: emergency and non-emergency mass notification and group messaging through text alerts, recorded voice messages, email and RSS feeds. Rave Guardian: user activates the application and if it will not be deactivated after certain time an alert will be send to police. Similarly pressing a “panic button” can send the alert. Rave Campus: Mobile phone users can access personalized sites with services, alerts to all users, including two previous products.

Reverse 911 [6]. Reverse 911 services are similar to those from Rave Wireless. Reverse 911 sends alerts to groups of users via various devices. Campus Emergency Notification adapts alerting for campus needs.

Another commercial solution, On-Star™ [7] was established in 1996 as an in-vehicle safety and security system to protect people on the road and provide immediate attention to people involved in road accidents or emergency situations on the move. Currently, On-Star has over 2 million subscribers in the USA. It connects an in-vehicle system and an On-Star Center through telematics services. OnStar's in-vehicle safety, security, navigation and positioning information services use Global Positioning System (GPS) satellite and cellular technology to link the vehicle and driver to the On-Star Center. At the On-Star Center, advisors offer real-time, personalized help. Examples of On-Star safety features are the following. Automatic Crash Response (ACR): this service involves the use of in-vehicle sensors to alert the advisors at On-Star Center when a subscriber's vehicle is involved in a crash to send for assistance. On-Star Turn-by-Turn Navigation: through voice-guided directions, it helps subscribers find their way to an address, business etc. using the On-Star database. Crisis Assist: during severe weather, natural disasters, or other crisis events, subscribers can push the in-vehicle red or blue On-Star button to access additional services. Stolen Vehicle Assistance: Subscribers can call and report a stolen vehicle and the On-Star Center can use the in-vehicle positioning system to help locate the vehicle. Remote Door Unlock: The On-Star advisors can remotely unlock a subscriber's vehicle on provision of account information and secret PIN number in the event that the subscriber's key is lost or stolen.

### 3. Limitations of Known Systems

For emergency applications, widespread cell-phone use and the need for time-consuming language translation have caused workloads and costs to jump for 911 dispatch centers across the nation. Statistical evidence proves that one incident can generate a large number of calls to report the same event. For example, it was already noticed in 2008, that since 2000, annual wireless 911 calls in Fairfax, Va. alone have risen from 180,000 to 268,000, an almost 50 percent increase [8]. Call volumes have increased across the United States, with widespread cell-phone use to report emergencies, causing 911 calling to jump from 150 million calls in 2000 to 240 million in 2007, according to the Association of Public Safety Communications Officials. Demand for language translation also exerts pressure on emergency dispatch centers. Thus, continuing load increase of E911 service calls is a major limitation of the existing emergency response system.

Another problem of the E911 system is its dependency on existing communication infrastructure, which can be seriously damaged during major disasters such as earthquakes, hurricanes, and terrorist attacks. For example, during hurricane Katrina, many people lost communications instantly, many others were able to call to E911 but the channels were not responding because of significant call volumes [8]. It is also noticed that once power sources failed, the ability to establish contact with first responders diminished [8]. A congressional report on hurricane Katrina indicated the need in consolidating responder services both administratively and technologically [8].

For non-emergency applications, even though public N-1-1 services provide various reporting channels, it is often hard to identify worthy/non-worthy issues to report. Potential first responders and witnesses are often not well informed on numbers to call, challenged by the large number of options. Commercial systems offer services to users who are willing to pay fees for enhanced safety.

Both public and commercial services are not designed to collect witness reports, which may potentially be valuable later but perhaps, do not indicate enough evidence to respond promptly. Public services include human operators in the chain, which increases reporting time with embedded human errors.

### 4. Recent Evolution of Emergency Services

As Voice over IP telephony (VoIP) gained wide popularity, the FCC has taken steps to require that providers of VoIP services that use Public Switched Telephone Network meet E911 requirements [10]. The report on hurricane Katrina [8] indicated several instances of internet connection availability when conventional communication channels were destroyed. The FCC also recognized that the importance of text messaging for emergency needs and offered Text-to-911 as a supportive feature starting 2014 [11]. An example application is shown in FIG. 1. Thus FCC tries to use emerging technologies for improving efficiency of emergency responses and this trend will continue.

At the same time, engineering communities have suggested new concepts that can address existing challenges of emergency and non-emergency public services. In particular, structured information format of communication may significantly reduce the call volumes by making use of a standardized reporting user interface (UI), which facilitate and automates the reporting process [12]. FIG. 2 shows an example of such interface that prompts user to select reporting phenomena from an existing menu of choices through consecutive UI option selections. This idea has been further developed by many other researchers for various platforms and for a variety of new features.

It is also suggested to use UAVs as cellular base-stations for first responder emergency teams [13] and as a general network element solution in [13]. The drawback of this approach is the need of continuous availability of UAVs to support existing communication paradigm.

While all of the aforementioned approaches may fulfill their unique purposes, none of them fulfill the need for a practical and effective means for providing a mobile UAV-based emergency communication scanner.

The present invention therefore proposes a novel systems and methods for a mobile UAV-based emergency communication scanner that addresses the shortcomings of the prior art.

### BRIEF SUMMARY OF THE INVENTION

The present invention, therefore, provides systems and methods for a mobile UAV-based emergency communication scanner.

The UAV based emergency communication system in an embodiment, is comprised of: at least one unmanned aerial vehicle (UAV) and at least one deployed sensor resource. In another embodiment, the UAV based emergency communication system is further comprised of a mapping application. In yet another embodiment, the UAV based emergency communication system is further comprised of a big-data center.

A sensor resource is a single agent of the overall system and represents a group of sensors and handheld devices to collect agent-representative data automatically or with the intervention of humans using appropriate man-machine interfaces. Human-originated data may include text, voice, video or other multimedia formats. Other sensor data may include activity signals from on-body or smartphone accelerometers, gyros, location information from GPS, WLAN-positioning, and information generated from other handheld devices, including derivative data from these sensors and devices.

Sensor data is collected as a package in a suitable format and will be communicated to UAVs when they are in the vicinity of the sensor resource, requesting sensor data. Sensor data is typically encoded in certain electronic formats and may be packaged in various aggregation formats of sensor data such as but not limited to a file, which contains readings from various sensors or several files communicated in sequence and distributed sensor data in one or another way. The UAVs act as sensor data scanners, collecting data from an area of interest and communicating it to a data center in real time or after returning back from the mission. The data centers will map sensor data using dedicated software applications and hardware equipment to show the global picture and distribution of sensor data to human operators.

UAVs can use short-range communication options to collect data, which will save battery power of involved transceivers. These short-range communication options may be for example and not a limitation, communication signals that are propagated limited or short range distances. For example, WLAN signals may propagate up to 400 meters outdoors, Bluetooth signals may propagate shorted distances as is known in the art, and cellular communication signals may propagate up to 30 miles in open areas. As the system's UAVs approach closer, they can use short range communication signals such as WLAN and Bluetooth. UAVs use cooperative optimal paths resulted from distributed, smart trajectory plannners based on the statistical distribution of mission parameters, prediction of target sensor resource locations, perceived threat priorities, and other mission related statistics.

Human-originated sensor data can be structured by tailored applications for fast human data entry and convenient human-machine interactions. The well-defined structure of this data will also help to automate the processing on operator side, as it formalizes and transforms responses to a discrete set of formal choices.

The disclosed systems and methods have several advantages over conventional systems. In bandwidth limited scenarios, communication of a large number of people may overwhelm the available communication channels. In emergency situations these communication channels may not be even available. In the proposed system data are collected in a distributed manner, and real-time random communication of sensor resources is replaced by localized collection of data by UAVs to avoid the high-burst-communication volume. In the absence of UAVs, the communication system and deployed sensor resources in embodiments, should be able to provide offline data collection capabilities to minimize the stress on the network. In addition it may consecutively communicate with the sensor resources collecting data in a time-distributive manner. The UAVs resolve the data collection problem when conventional communication channels are not available, and they may also collect additional visual data from areas of interest. Short-range communication with UAVs allows minimizing transmitted signal power which is important for autonomous operations. The invention can be used in many applications including but not limited to the following:
1. Variety of emergency scenarios. Search and rescue operations.
2. Military operations with reduced range of radio-signaling exposure.
3. Collecting wide area sensor data, such as gas and water meters, agricultural sensors etc, in rural areas with low networking resource.
4. Any distributed sensor data collection applications in areas without wireless communication infrastructure using multiple ground-based sensors. For example, law enforcement applications such as tracking criminals and commercial applications involving surveillance, reconnaissance, and information collection.

Other embodiments of the invention are discussed throughout this application. Any embodiment discussed with respect to one aspect applies to other aspects as well and vice versa. Each embodiment described herein is understood to be embodiments that are applicable to all aspects of the invention. It is contemplated that any embodiment discussed herein can be implemented with respect to any system, device, method, or composition, and vice versa. Furthermore, systems, compositions, and kits of the invention can be used to achieve methods of the invention.

In summary, the present invention generally relates to systems and methods for communication scanners. More specifically, the present invention relates to systems and methods for communication scanners, which utilize mobile-based platforms to facilitate the communications.

### BRIEF DESCRIPTION OF THE SEVERAL VIEWS OF THE DRAWINGS

For a more complete understanding of the features and advantages of the present invention, reference is now made to the detailed description of the invention along with the accompanying figures in which:

FIG. 1 is an interface layout of a text to 911 application;

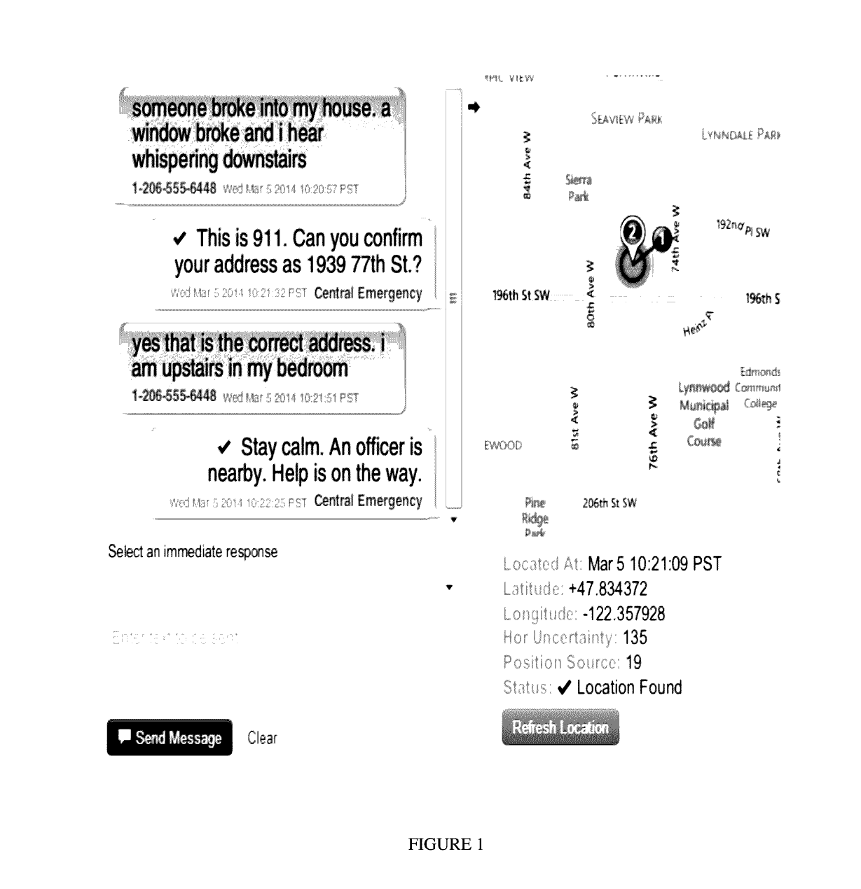

FIG. 2 is an interface layout which helps facilitate an automated reporting process;

FIG. 3 is a system architecture of the mobile UAV based emergency communication scanner system in accordance with embodiments of the present disclosure; and

FIG. 4 is an additional system architecture of the mobile UAV based emergency communication scanner system in accordance with embodiments of the present disclosure.

### DETAILED DESCRIPTION OF THE INVENTION

Disclosed herein are improved systems and methods for a mobile UAV emergency communication scanner or response system. The numerous innovative teachings of the present invention will be described with particular reference to several embodiments (by way of example, and not of limitation).

This invention addresses several challenges that are observed in communication-limited areas:
1. Conventional communication infrastructure might be limited in rural areas, disaster zones (earthquakes, hurricanes, tornados, terrorist attacks, etc), war torn areas, etc.
2. Conventional communication relies on continuous availability of communication channels which are not always available.
3. Communication channels might be jammed when used by many responders.

To address these limitations, the invention utilizes one or more of the following approaches: mobile base-stations or platforms (scanner) including UAV-based platforms, offline message entry (to include data collection and communication), structured information entry, smart trajectory planning of the communication relay platforms, sensor management of UAVs. In embodiments, mobile base-stations may be for example and not a limitation, automobiles, motorized vehicles, ground vehicles, and even first responders (individuals). That is the mobile base-stations may be enabled by any mobile agent. More detailed description now follows:

All the challenges aforementioned are solved by establishing scanner-like communication services. In this concept, the user prepares his message, data, or communication in an offline mode, and this message remains pending until a dedicated mobile base-station will be in the vicinity and will read/collect the message, data, or communication. The base-station may also communicate with the sender. The base-station may exploit directional antennas, transmission power control trajectory planning to scan different areas one after another, retrieve pending messages and even respond using conventional communication signaling. A novelty aspect of this invention is in the usage of semi-offline communication channels, that are able to handle pending messages, rather than online calls. Data collection as used herein may be for example and not a limitation data collected from various sensors such as and not limited to GPS, accelerometers, cameras, and thermometers.

The implementation may use ad-hoc signaling or existing modulation waveforms. This approach is an extension of SMS and MMS services that are able to save user messages and ensure their transmission at a later time when communication channels become available. Different from these services though, the service is supported by mobile base-stations that are able to retrieve the messages without conventional communication infrastructure. The approach is different from other mobile base-station solutions by focusing on offline messaging for massive data collection without integration of the autonomous mobile base-station in the conventional communication infrastructure, which will require continuous presence of the UAV. In other words, the concept of “connectivity at any place and at any time” at the cost of infrastructure, which is not designed for all emergency scenarios, is replaced by the concept of guaranteed periodic collection and posting of messages without infrastructure that can be damaged during disasters. That is, the mobile based communication scanner is configured to be communicatively coupled with the deployed sensor resource.

To resolve the problem of channel jamming by many users, the mobile base-stations control the coverage by limiting transmission power, through diversity mechanisms such as antenna directionality, consecutive area scanning, etc.

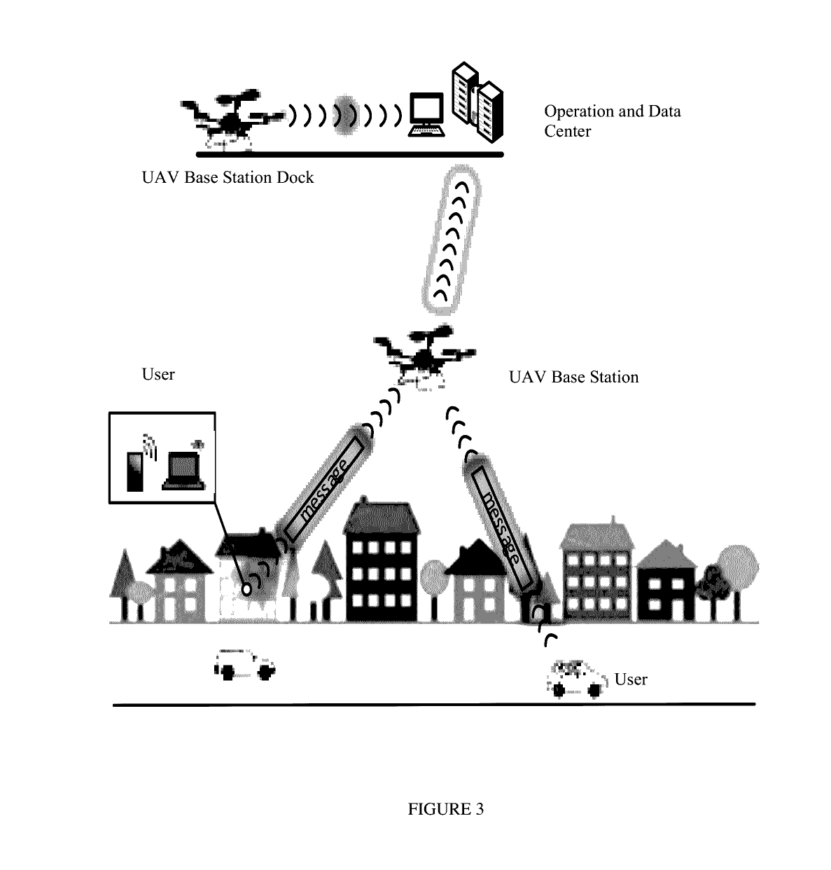

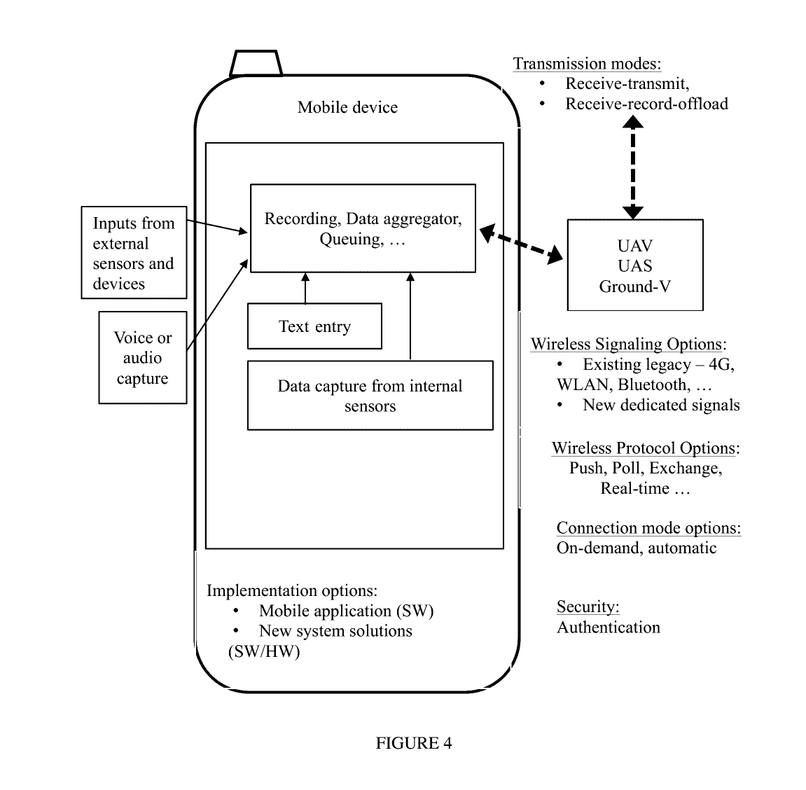

The dedicated mobile base-station is integrated in UAVs that fly through the area of interest. The UAVs are configured to collect data and send immediately back to a big data center, or offload the data at the big data center when returning back from the mission. They may also send responses to message sources. Depending on mission goals, the mobile base-station is used for establishing conventional communication link with the user on the ground in the absence of conventional communication infrastructure. The concept and system architecture of the mobile UAV based communication scanner is illustrated in FIG. 3 and FIG. 4.

The pending message includes readings from various sensors that will be packaged in a tailored communication protocol for joint transmission when the communication scanner is available. State-of-the-art sensor management approaches is used for this purpose. The message source in embodiments is not human, but an electronic device that collects sensor data and communicates to the scanner.

The base-station mobility is supported by an advanced trajectory planner, which is configured to determine optimal trajectories in real-time or offline in terms of fast data collection depending on infrastructure and statistical expectations of originating resource locations.

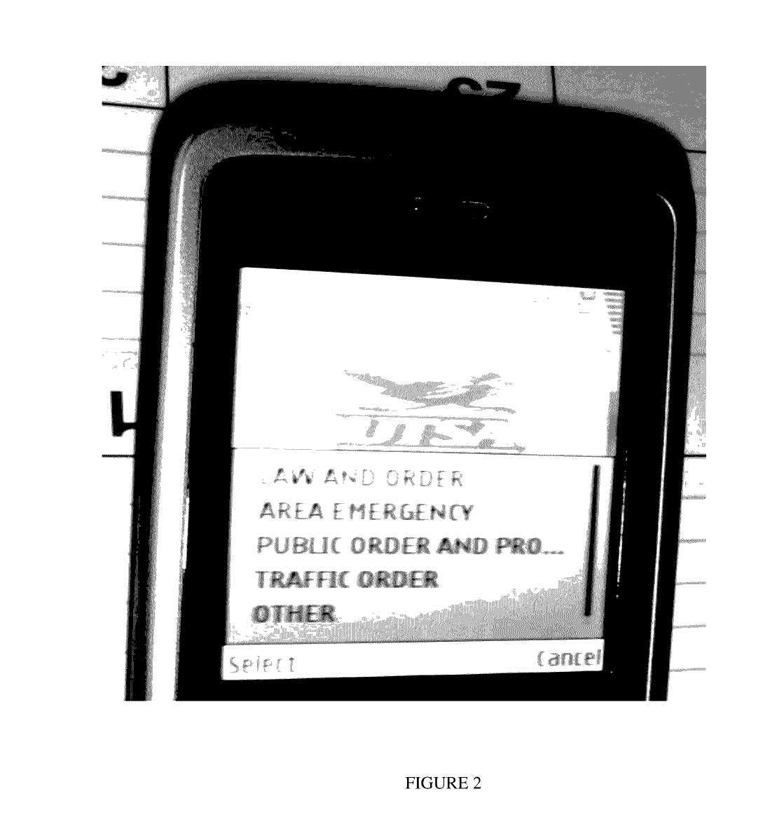

Message entry by users includes manual or automatic indexing (or tagging), i.e. standardized characterization of messages for facilitated processing at the destination. For example, reporting events using standard event selection menu (similar to FIG. 2) will automatically index the selection and transmit the event's index instead of event's description. Various types of messages such as voice, images, video, etc. can be combined in one package following existing similar practices.

Message entry by users is facilitated using state-of-the-art approaches in UI design such as effectiveness, efficiency, satisfaction, and other criteria. In this context, effectiveness is typically measured as the percentage of tasks solved. Efficiency is typically measured by three parameters: task completion time (in seconds), a number of hierarchical levels in the menu used to complete the task and the number of detour steps (number of returns to a higher level in the menu). Satisfaction is typically measured per task by using after-scenario surveys which addresses three components of user satisfaction with system usability: ease of task completion, time to complete a task and adequacy of support information.

In brief, as described herein provides for an effective and efficient mobile UAV communication scanner or response system.

The disclosed systems and methods are generally described, with examples incorporated as particular embodiments of the invention and to demonstrate the practice and advantages thereof. It is understood that the examples are given by way of illustration and are not intended to limit the specification or the claims in any manner.

To facilitate the understanding of this invention, a number of terms may be defined below. Terms defined herein have meanings as commonly understood by a person of ordinary skill in the areas relevant to the present invention.

Terms such as “a”, “an”, and “the” are not intended to refer to only a singular entity, but include the general class of which a specific example may be used for illustration. The terminology herein is used to describe specific embodiments of the invention, but their usage does not delimit the disclosed systems or methods, except as may be outlined in the claims.

Any embodiments comprising a one component or a multi-component system having the structures as herein disclosed with similar function shall fall into the coverage of claims of the present invention and shall lack the novelty and inventive step criteria.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific systems and methods described herein. Such equivalents are considered to be within the scope of this invention and are covered by the claims.

All publications, references, patents, and patent applications mentioned in the specification are indicative of the level of those skilled in the art to which this invention pertains. All publications, references, patents, and patent application are herein incorporated by reference to the same extent as if each individual publication, reference, patent, or patent application was specifically and individually indicated to be incorporated by reference.

In the claims, all transitional phrases such as “comprising,” “including,” “carrying,” “having,” “containing,” “involving,” and the like are to be understood to be open-ended, i.e., to mean including but not limited to. Only the transitional phrases “consisting of” and “consisting essentially of,” respectively, shall be closed or semi-closed transitional phrases.

The systems and/or methods disclosed and claimed herein can be made and executed without undue experimentation in light of the present disclosure. While the systems and methods of this invention have been described in terms of preferred embodiments, it will be apparent to those skilled in the art that variations may be applied to the systems and/or methods and in the steps or in the sequence of steps of the method described herein without departing from the concept, spirit, and scope of the invention.

More specifically, it will be apparent that certain components, which are both shape and material related, may be substituted for the components described herein while the same or similar results would be achieved. All such similar substitutes and modifications apparent to those skilled in the art are deemed to be within the spirit, scope, and concept of the invention as defined by the appended claims.

### REFERENCES

1. North American Numbering Plan Administration. N-1-1 codes. http://www.nanpa.com/number_resource_info/n11_codes.html
2. Federal Communication Commission. Enhanced E911 Wireless Services. http://www.fcc.gov/pshs/services/911-services/enhanced911/Welcome.html
3. Federal Communication Commission. Public Safety Answering Points (PSAP). http://www.fcc.gov/pshs/services/911-services/enhanced911/psapregistry.html
4. Federal Emergency Management Agency (FEMA). www.fema.gov.
5. Rave Wireless. http://www.ravewireless.com/home
6. Reverse 911. www.reverse911.com
7. On-Star by GM. http://www.onstar.com/us_english/jsp/index.jsp
8. The Washington Post. Cell phones drive jump in 911. http://www.washingtonpost.com/wp-dyn/content/article/2008/10/25/AR2008102502052.html
9. CRS Report for Congress. An Emergency Communications Safety Net: Integrating 911 and Other Services. Order Code RL32939. September 2005. http://www.fas.org/sgp/crs/homesec/RL32939.pdf
10. FCC: Interconnected VoIP 911 service. http://www.fcc.gov.guides/voip-and-911-service
11. FCC: Text-to-911 Service. http://www.fcc.gov/text-to-911
12. A. Kumar, D. Akopian, P. Chen, “Development of a Mobile Preventive Notification System (PreNotiS)”, Proceeding of SPIE Multimedia on Mobile Devices Conference, Electronic Imaging, January 18-22, San Jose, Calif., 2009.
13. R. Varga, “COMM-OPS: UAV Cellular payload for first responder emergency teams,” MilSat Magazine, http://www.milsatmagazine.com/story.php?number=1435005486
14. T. Wypych, “AirGSM: An unmanned, flying GSM cellular basestation for flexible field communications,” IEEE Aerospace Conference, Mar. 3-10, 2012, BigSky, Mont. DOI: 10.1109/AERO.2012.6187134

What is claimed is:

1. A communication scanner system comprising:
at least one mobile communication scanner; and
at least one deployed sensor resource;
wherein said mobile communication scanner and said deployed sensor resource are configured to be periodically communicatively coupled to each other when scans are performed by said mobile communication scanner; and
wherein said deployed sensor resource are configured to store data and communications which are periodically collected by said mobile communication scanner.

2. The communication scanner system of claim 1, wherein said mobile communication scanner is a motorized vehicle.

3. The communication scanner system of claim 1, wherein said mobile communication scanner is a motorized ground vehicle.

4. The communication scanner system of claim 1, wherein said mobile communication scanner is an automobile.

5. The communication scanner system of claim 1, wherein said mobile communication scanner is a unmanned aerial vehicle.

6. The communication scanner system of claim 5, further comprising a mapping application.

7. The communication scanner system of claim 5, further comprising a big data center communicatively coupled with said mobile communication scanner.

8. The communication scanner system of claim 5, further comprising an advanced trajectory planner for controlling the trajectories of said mobile communication scanner.

9. The communication scanner system of claim 8, wherein said advanced trajectory planner is configured to determine optimal trajectories for fast data collection in real-time or offline.

10. The communication scanner system of claim 1, wherein said stored data and communications remain pending until a mobile based station collects said stored data and communications.

11. The communication scanner system of claim 1, wherein said communication coupling is comprised of SMS services.

12. The communication scanner system of claim 1, wherein said communication coupling is comprised of MMS services.

13. The communication scanner system of claim 1, wherein said communication coupling is comprised of ad-hoc signaling.

14. The communication scanner system of claim 1, wherein said communication coupling is comprised of existing modulation waveforms.

15. The communication scanner of claim 7, wherein said mobile communication scanner is configured to collect said data and said communications for sending immediately or sending upon return back from mission to said big data center.

16. The communication scanner of claim 1, wherein said deployed sensor resource is configured with manual or automatic indexing.

17. The communication scanner of claim 1, wherein said deployed sensor resource is configured with a user interface for entering data and communications.

18. The communication scanner of claim 1, wherein said mobile communication scanner is a unmanned aerial vehicle; further comprising a mapping application; further comprising an advanced trajectory planner for controlling the trajectories of said mobile communication scanner; and wherein said advanced trajectory planner is configured to determine optimal trajectories for fast data collection in real-time or offline.

19. The communication scanner of claim 18, wherein said stored data and communications remain pending until a mobile based station collects said stored data and communications, and wherein said communication coupling is comprised of ad-hoc signaling and existing modulation waveforms.

20. The communication scanner of claim 19, wherein said mobile communication scanner is configured to collect said data and said communications for sending immediately or sending upon return back from mission to said big data center, and wherein said deployed sensor resource is configured with manual or automatic indexing, and wherein said deployed sensor resource is configured with a user interface for entering data and communications.
